(19) United States
(12) Patent Application Publication
(10) Pub. No.: US 2013/0027717 A1
(43) Pub. Date: Jan. 31, 2013

(54) PRINTING DEVICE

(71) Applicant: Naoki HASHIMOTO, Nagoya-shi (JP)

(72) Inventor: Naoki HASHIMOTO, Nagoya-shi (JP)

(73) Assignee: Brother Kogyo Kabushiki Kaisha, Nagoya-shi (JP)

(21) Appl. No.: 13/464,398

(22) Filed: May 4, 2012

(30) Foreign Application Priority Data
Jul. 26, 2011 (JP) 2011-163322

(51) Int. Cl. G06K 15/02

(52) U.S. Cl. 358/1.2; 358/1.15; 358/1.14

(57) ABSTRACT

A printing device includes an acquiring section, a determining section, a selecting section, and a printing section. The acquiring section is configured to access, based on reference information, a reference location on a network and to acquire print data from the reference location. The determining section is configured to determine whether the print data are constituted by a plurality of frames. The selecting section is configured to select at least one of the plurality of frames as a print target based on a user instruction when the determining section determines that the print data are constituted by the plurality of frames, and to select a single frame as the print target when the determining section determines that the print data are constituted by the single frame. The printing section is configured to print the print target selected by the selecting section.

### CROSS REFERENCE TO RELATED APPLICATIONS

This application claims priority from Japanese Patent Application No. 2011-163322 filed Jul. 26, 2011. The entire content of the priority application is incorporated herein by reference.

### TECHNICAL FIELD

The invention relates to a printing device and a storage medium storing a set of program instructions for controlling a printing device.

### BACKGROUND

A printing device is conventionally known that acquires reference information of data, that acquires the data from a reference location of the reference information, and that performs printing. For example, a printing device is conventionally known that acquires URL information for referring to a Web page, that acquires print data (contents) from the Web page that is a reference location of the URL information, and that performs printing.

### SUMMARY

It is an object of the invention to provide a printing device that facilitates obtaining a print result reflecting user's intention when printing is performed for data having a plurality of frames, and a storage medium storing a set of program instructions for controlling such a printing device.

In order to attain the above and other objects, the invention provides a printing device. The printing device includes an acquiring section, a determining section, a selecting section, and a printing section. The acquiring section is configured to access, based on reference information, a reference location on a network and to acquire print data from the reference location. The determining section is configured to determine whether the print data are constituted by a plurality of frames. The selecting section is configured to select at least one of the plurality of frames as a print target based on a user instruction when the determining section determines that the print data are constituted by the plurality of frames, and to select a single frame as the print target when the determining section determines that the print data are constituted by the single frame. The printing section is configured to print the print target selected by the selecting section.

According to another aspect, the invention also provides a storage medium storing a set of program instructions executable on an information processing device. The set of program instructions includes: accessing, based on reference information, a reference location on a network and acquiring print data from the reference location; determining whether the print data are constituted by a plurality of frames; and selecting at least one of the plurality of frames as a print target based on a user instruction when the print data are constituted by the plurality of frames, and selecting a single frame as the print target when the print data are constituted by the single frame.

According to still another aspect, the invention also provides a printing device. The printing device includes a processor, a network interface, a memory, and a printing device. The network interface is connectable to a network. The memory stores a set of program instructions executable by the processor. The set of program instructions includes: accessing, based on reference information, a reference location on the network and acquiring print data from the reference location through the network interface; determining whether the print data are constituted by a plurality of frames; and selecting at least one of the plurality of frames as a print target based on a user instruction when the print data are constituted by the plurality of frames, and selecting a single frame as the print target when the print data are constituted by the single frame. The printing device is configured to print the print target.

### BRIEF DESCRIPTION OF THE DRAWINGS

Embodiments in accordance with the invention will be described in detail with reference to the following figures wherein:

FIG. 1 is a block diagram showing the electrical configuration of a printer according to a first embodiment;

FIG. 2 is a view showing a setting screen (first screen) of Web page printing;

FIG. 3 is a flowchart showing steps in a Web-page printing process by the printer;

FIG. 4 is a view showing a selecting screen (frame-map display) for selecting a frame manually;

FIG. 5 is a view showing a selecting screen (keyword display) for selecting a frame manually;

FIG. 6 is a view showing a selecting screen (area-ratio display) for selecting a frame manually;

FIG. 7 is a flowchart showing steps in a font changing process according to the first embodiment;

FIG. 8 is a view showing a setting screen (second screen) of Web page printing;

FIG. 9 is a view showing a selecting screen for specifying a text size manually;

FIG. 10 is a flowchart showing steps in a Web-page printing process by a PC, according to a second embodiment of the invention; and

FIG. 11 is a flowchart showing steps in a Web-page printing process according to a third embodiment of the invention.

### DETAILED DESCRIPTION

### First Embodiment

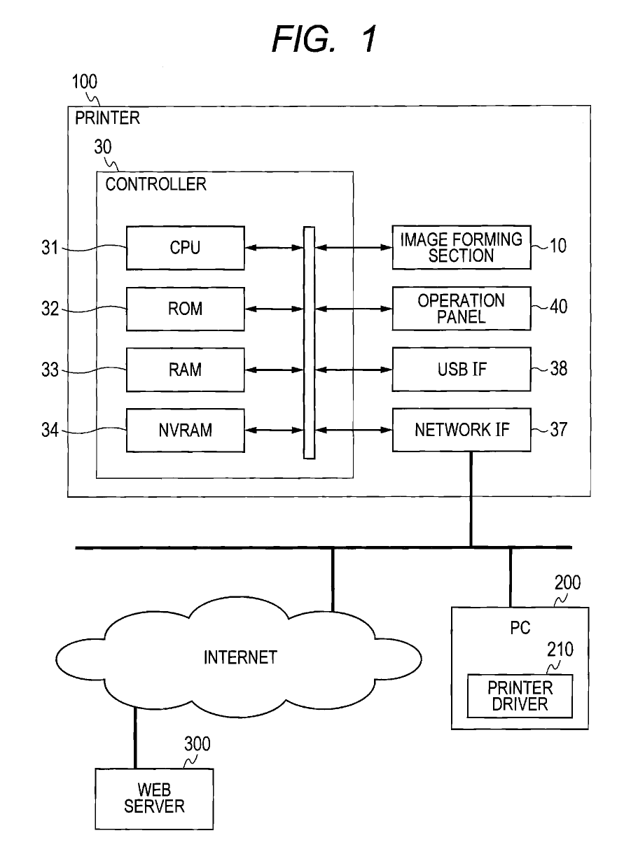

A printer embodying a printing device according to a first embodiment of the invention will be described while referring to FIGS. 1 through 9. In the present embodiment, the invention is applied to a printer having a function of acquiring print data from a Web page and of performing printing.

[Configuration of Printer]

As shown in FIG. 1, a printer 100 (an example of a printing device) of the present embodiment includes a controller 30 having a CPU 31, a ROM 32, a RAM 33, and an NVRAM (Non Volatile RAM) 34. The controller 30 is electrically connected with an image forming section 10 that prints an image on paper, an operation panel 40 that displays operating conditions and that receives input operations by a user, a network interface 37, and a USB interface 38.

The ROM 32 stores firmware, various settings, initial values, and the like. The firmware is a control program for controlling the printer 100. The RAM 33 and the NVRAM 34 are used as a work area to which various control programs are read out, or as a storage area for storing print data temporarily. The NVRAM 34 (an example of a condition storage section and a text-size storage section) is also used as a storage area for storing various settings that are set by a user after shipment.

The CPU 31 (an example of an acquiring section, a determining section, a selecting section, a designating section, a setting section, a text-size specifying section, a first changing section, an authenticating section, a text-size acquiring section, and a second changing section) controls each element of the printer 100 while storing its processing results in the RAM 33 or in the NVRAM 34 in accordance with control programs read out from the ROM 32 and signals sent from various sensors.

The network interface 37 and the USB interface 38 are interfaces that enable communication with other devices. The printer 100 receives data sent from the other devices via these interfaces.

In the present embodiment, the printer 100 performs communication, via the network interface 37, with a personal computer (PC) 200 in which a printer driver 210 for the printer 100 is installed and with a Web server 300 storing a Web page.

In addition, other devices may be used via the USB interface 38. For example, if a flash memory is connected to the USB interface 38, the flash memory can be used as a storage area. Further, if a keyboard is connected, the keyboard can be used to perform input operations.

The image forming section 10 (an example of a printing section) prints an image on paper. Here, a type of forming images may be an electrophotographic type or an inkjet type. Further, the image forming section 10 may be for color printing or only for monochromatic printing.

The operation panel 40 (an example of an informing section) has various buttons for receiving user inputs and a touch-panel screen for displaying text information, buttons, and the like. The various buttons include, for example, an OK button for starting a print operation and a cancel button for cancelling a print operation.

[Control by Printer]

Next, controls by the printer 100 will be described. The printer 100 of the first embodiment has a Web-page printing function of acquiring URL information (Uniform Resource Locator information, an example of reference information) for referring to a Web page, acquiring print data (contents) from the Web page based on the URL information, and printing the contents. Here, the reference information is information for identifying a storage location of data.

When performing Web page printing, first, a user operates the operation panel 40 to input an instruction for executing Web page printing. Upon receiving the instruction, the printer 100 displays an input screen for urging the user to input URL information. The user inputs the URL information of a Web page on the input screen. For example, in order to print information of a Web page stored in a predetermined directory of the Web server 300 (see FIG. 1), the user inputs URL information including the directory path. Then, the user presses the OK button of the operation panel 40.

When the OK button is pressed, the printer 100 acquires inputted URL information, accesses the predetermined directory of the Web server 300 based on the URL information, and downloads print data into a memory area (the RAM 33 and the NVRAM 34). Then, the printer 100 performs printing of downloaded print data.

Here, some downloaded print data have a plurality of image regions (frames). On the other hand, because the touch-panel screen of the printer 100 does not have a function of displaying a downloaded Web page, a user often inputs a print instruction without knowing whether print data include a plurality of frames. Thus, it is difficult to expect that a user voluntarily selects a frame of a print target. Hence, the printer 100 analyzes frame construction of print data and, if the print data include a plurality of frames, prompts a user to select whether to print the entirety as a single print target or to perform printing on a frame-by-frame basis. Further, if printing is performed on a frame-by-frame basis, the printer 100 prompts the user to select which frame is to be printed.

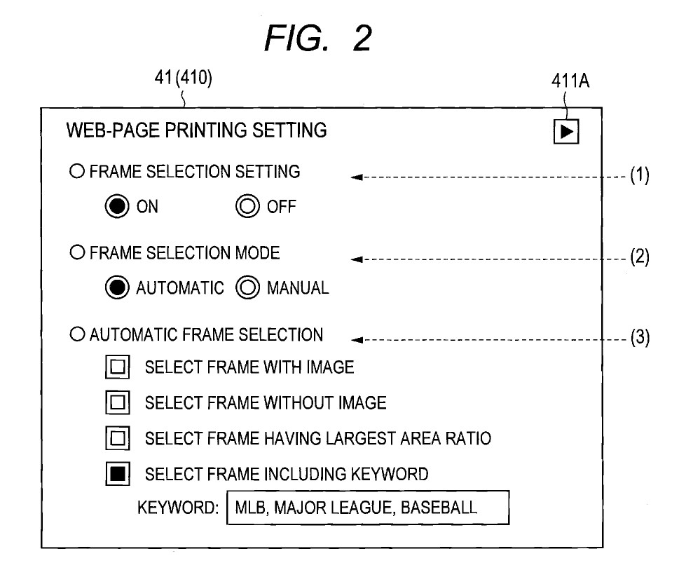

Specifically, the printer 100 displays a Web-page printing setting screen 410 shown in FIG. 2 on a touch-panel screen 41 of the operation panel 40, thereby receiving, from a user, settings of how to select a frame. Prior to inputting an instruction for executing Web page printing, the user preliminarily performs setting of how to select a frame. The Web-page printing setting screen 410 includes a frame-selection setting for setting whether to perform printing on a frame-by-frame basis ((1) in FIG. 2), a frame-selection-mode setting for setting whether to select a frame automatically by the printer 100 or manually ((2) in FIG. 2), and an automatic-frame-selection setting for setting which criterion to use to select a frame when the printer 100 automatically selects a frame ((3) in FIG. 2). The settings are stored in the NVRAM 34. Each selection mode will be described later in detail.

[Web-Page Printing Process]

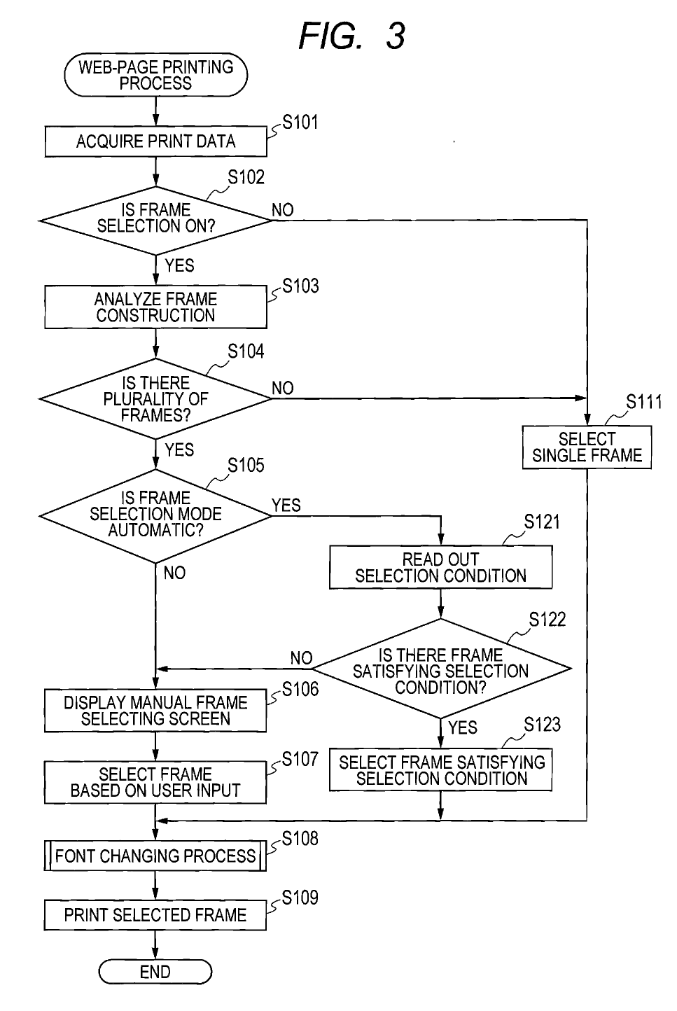

Next, a Web-page printing process (an example of the acquiring section, the determining section, the selecting section, and the designating section) for implementing the above-described Web-page printing function will be described while referring to the flowchart in FIG. 3. The CPU 31 starts the Web-page printing process upon receipt (detection) of pressing of the OK button (as a trigger) after URL information is inputted.

In the Web-page printing process, first, the CPU 31 acquires the inputted URL information and acquires print data based on the URL information (S101, an example of the acquiring section). That is, the CPU 31 accesses a Web page at a reference location indicated by the URL information and downloads print data.

Next, the CPU 31 determines whether the frame-selection setting ((1) in FIG. 2) is ON (S102). If the frame-selection setting is OFF (S102: No), a print target is treated as a single image even if the print target includes a plurality of frames. Hence, the entirety is treated as a single frame. The CPU 31 selects the single frame (S111) and proceeds to S108.

If the frame-selection setting is ON (S102: Yes), the CPU 31 analyzes frame construction of print data acquired in S101 (S103). Specifically, the CPU 31 analyzes layout and size of each frame. Additionally, the CPU 31 analyzes text information included in each frame as necessary.

Next, the CPU 31 determines whether the print data have a plurality of frames (S104, an example of the determining section). If the print data do not have a plurality of frames, that is, if the print data are constituted by a single frame (S104: No), the CPU 31 selects the single frame (S111, an example of the selecting section) and proceeds to S108.

If the print data have a plurality of frames (S104: Yes), the CPU 31 determines whether the frame-selection-mode setting ((2) in FIG. 2) is automatic (S105). If the frame-selection-mode setting is not automatic, that is, if the user selects a frame manually (S105: No), the CPU 31 displays a manual frame selecting screen for allowing the user to select a frame on the touch-panel screen 41 of the operation panel 40 (S106).

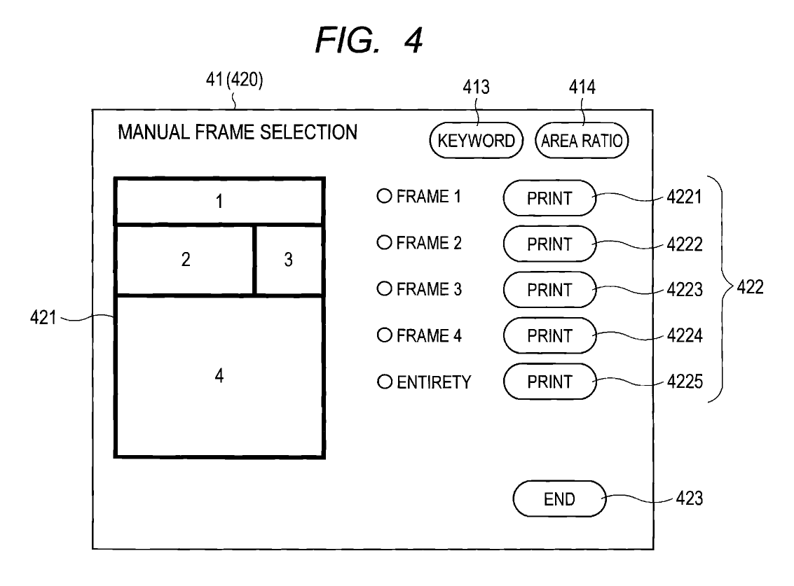

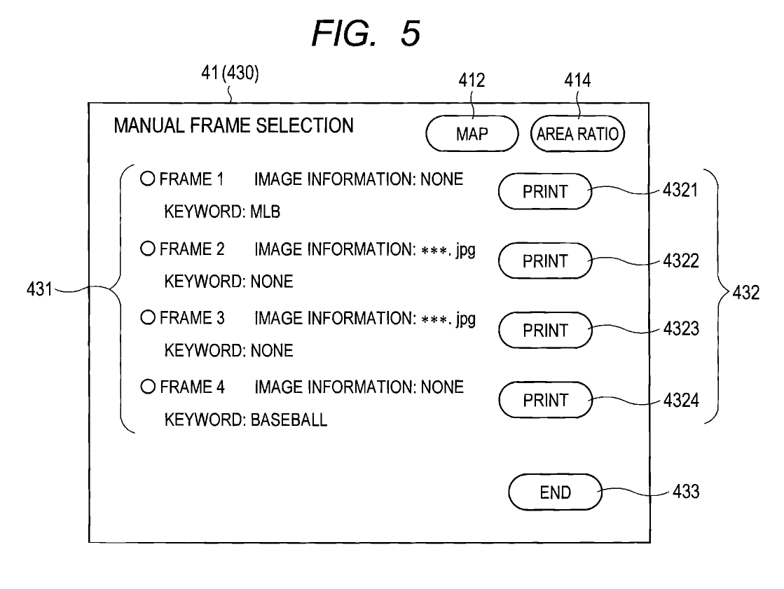

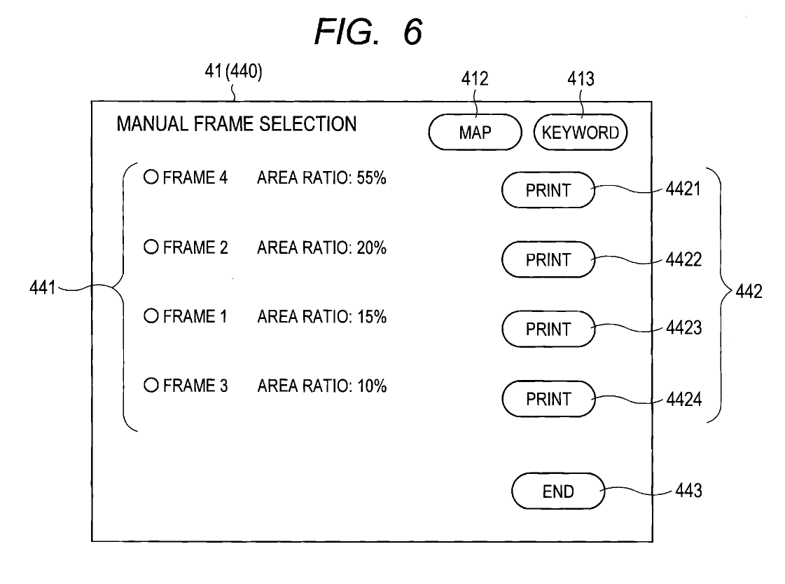

As the manual frame selecting screen, the printer 100 of the first embodiment has a frame-map display screen 420 that displays a frame layout as shown in FIG. 4, a keyword display screen 430 that displays a keyword included in each frame as shown in FIG. 5, and an area-ratio display screen 440 that displays a display area ratio of each frame to all of the frames as shown in FIG. 6. In S106, the CPU 31 displays the frame-map display screen 420 as an initial screen.

The frame-map display screen 420 includes a keyword button 413 for switching display to the keyword display screen 430 and an area-ratio button 414 for switching display to the area-ratio display screen 440. The keyword display screen 430 includes a map button 412 for switching display to the frame-map display screen 420 and the area-ratio button 414 for switching display to the area-ratio display screen 440. The area-ratio display screen 440 includes the map button 412 for switching display to the frame-map display screen 420 and the keyword button 413 for switching display to the keyword display screen 430. The map button 412, the keyword button 413, and the area-ratio button 414 enable the user to switch between each screen.

The frame-map display screen 420 (an example of the informing section) shown in FIG. 4 includes a frame map 421 illustrating the layout and size of each frame (arrangement relationships among the frames). As a display area of a frame relative to all the frames is larger, the frame tends to have a larger amount of information and tends to have more importance. In addition, a frame disposed at the center tends to have more importance. Hence, by displaying the frame map 421, the user can visually infer importance or the amount of information of each frame.

The frame-map display screen 420 includes print buttons 422 for respective frames (an example of the designating section), a print button 4225 for selecting the entirety as a single frame, and an end button 423. In FIG. 4, the print buttons 422 include print buttons 4221, 4222, 4223, and 4224 corresponding to four frames 1, 2, 3, and 4, respectively. The number of the print buttons 422 corresponds to the number of the frames, and is changed according to the number of the frames. If one of the print buttons 422 is pressed, the frame corresponding to the button is selected as a print target. If the print button 4225 is pressed, a single frame including all the frame as a single image is selected as a print target. If the end button 423 is pressed, the Web-page printing process is cancelled.

The keyword display screen 430 (an example of the informing section) shown in FIG. 5 includes a list 431 having image information and keyword information in each frame. Specifically, the list 431 includes information of whether each frame includes image information and, if so, shows a filename of the image data. The list 431 further includes information of whether each frame includes a keyword and, if so, shows the keyword included in the frame. Note that keywords are stored in the NVRAM 34, and that the user preliminarily registers keywords before the Web-page printing process is started. By extracting the keyword registered by a user from each frame, the user can infer whether each frame includes required information.

The keyword display screen 430 includes print buttons 432 for respective frames (an example of the designating section) and an end button 433. In FIG. 5, the print buttons 432 include print buttons 4321, 4322, 4323, and 4324 corresponding to four frames 1, 2, 3, and 4, respectively. The number of the print buttons 432 corresponds to the number of the frames, and is changed according to the number of the frames. If one of the print buttons 432 is pressed, the frame corresponding to the button is selected as a print target. If the end button 433 is pressed, the Web-page printing process is cancelled.

The area-ratio display screen 440 (an example of the informing section) shown in FIG. 6 includes a list 441 having an area ratio (occupancy ratio) of a frame to all the frames, for each frame. In the list 441, the frames are arranged in descending order of the area ratio. As the area ratio is larger, the frame tends to have a larger amount of information and tends to have more importance. Hence, by displaying the area ratio of each frame, the user can infer importance or the amount of information of each frame.

The area-ratio display screen 440 includes print buttons 442 for respective frames (an example of the designating section) and an end button 443. In FIG. 6, the print buttons 442 include print buttons 4421, 4422, 4423, and 4424 corresponding to four frames 1, 2, 3, and 4, respectively. The number of the print buttons 442 corresponds to the number of the frames, and is changed according to the number of the frames. If one of the print buttons 442 is pressed, the frame corresponding to the button is selected as a print target. If the end button 443 is pressed, the Web-page printing process is cancelled.

If one of the print buttons 422 and 4225 is pressed on the frame-map display screen 420, the keyword display screen 430, or the area-ratio display screen 440, the printer 100 selects the frame corresponding to the print button as a print target (S107, an example of the selecting section).

If the frame selection mode is automatic (S105: Yes), the CPU 31 reads out (extracts) a selection condition (S121). In the first embodiment, the automatic-frame-selection setting ((3) in FIG. 2) can be performed in the Web-page printing setting screen 410. As a selection condition, a frame with an image, a frame without an image, a frame having the largest area ratio, or a frame including a keyword can be set. The set selection condition is stored in the NVRAM 34 and is read out in S121 of the Web-page printing process.

For example, a frame having the largest area ratio tends to have the largest amount of information. Thus, by setting the frame having the largest area ratio as the selection condition, it is likely that a frame satisfying a user's desire is selected. In addition, for example, it is likely that a frame including a keyword registered by a user is a frame satisfying the user's desire. Registration and deletion of a keyword can be performed through inputting on the Web-page printing setting screen 410. A registered keyword is stored in the NVRAM 34. Further, for example, if a user wish to exclude data including only texts such as an index, it would be appropriate to set a frame with an image as a print target. In contrast, for example, if a user wish to exclude data mainly including images such as advertisement, it would be appropriate to set a frame without an image as a print target.

Next, based on the read-out selection condition, the CPU 31 determines whether there is a frame satisfying the selection condition (S122). If there is no frame satisfying the selection condition (S122: No), the CPU 31 proceeds to S106 and performs manual frame selection. If there is a frame satisfying the selection condition (S122: Yes), the CPU 31 selects a frame satisfying the selection condition as the print target (S123, an example of the selecting section).

After a frame of the print target is selected in S107, S123, or S111, the CPU 31 executes a font changing process for changing a text size of texts included in the frame, as necessary (S108). The font changing process of S108 will be described later in detail. Subsequent to the font changing process of S108, the CPU 31 controls the image forming section 10 to print the frame of the print target (S109, an example of the printing section). Subsequent to S109, the Web-page printing process ends.

### Comparative Example

There is a conventional printing device for printing a Web page. Such a printing device stores URL information and contents of a Web page that has been printed once and, when the Web page is printed next time, selects either printing the stored contents or printing updated contents acquired by referring to the URL information.

With this printing device, however if printing is performed for data having a plurality of image regions (frames) in a single screen, a user cannot necessarily obtain an intended print result. For example, a user wishes to print individual frames in some cases, and wishes to print the entire data in other cases. Hence, the print result does not necessarily match a user's intention.

In contrast, with the printer 100 according to the present embodiment, if print data include a plurality of frames, the printer 100 selects a frame of a print target in accordance with a user's manual selection (direct user's instruction) or a selection condition that is preliminarily set by the user (indirect user's instruction), prior to printing the print data. On the other hand, if print data only include a single frame, the printer 100 prints the single frame without asking the user. That is, the selection mode is changed depending on whether print data include a plurality of frames. Thus, the user's intention can be reflected in printing, and printing without reflecting the user's intention can be avoided. As a result, this reduces a possibility that a print result against the use's intention is obtained.

In the present embodiment, because a frame of a print target is automatically selected in accordance with a selection condition that is preliminarily set by the user, the user can save a trouble of selecting a frame every time.

In the present embodiment, a print target is selected at a timing subsequent to receiving a print instruction for the print data and prior to starting printing. This is because, if a user instruction is required before printing of print data becomes definite, it is bothersome for a user who does not wish to print.

[Font Changing Process]

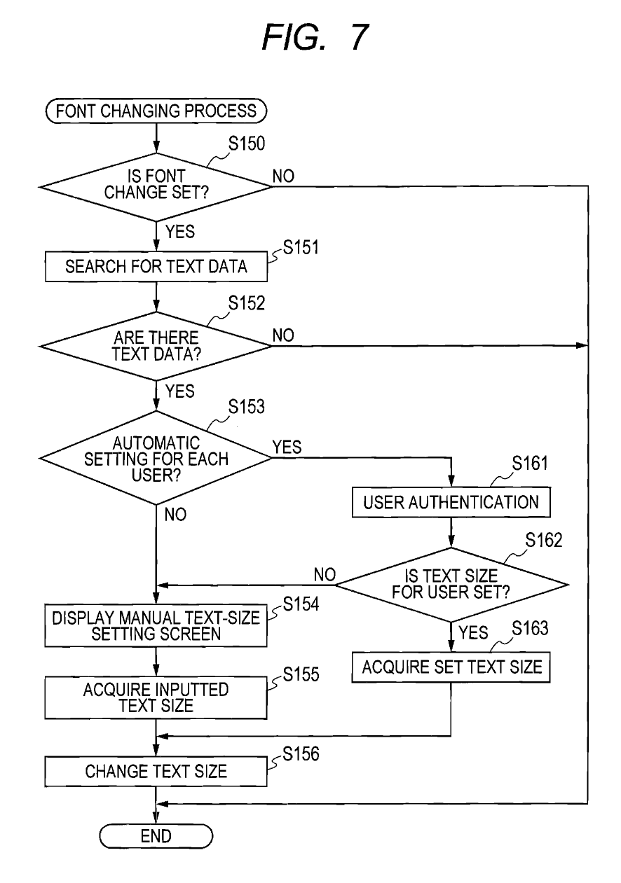

Next, the font changing process (an example of the first changing section, the authenticating section, the text-size acquiring section, and the second changing section) of S108 in the Web-page printing process will be described while referring to the flowchart in FIG. 7.

There is a difference among individuals in how easily texts in print data can be read, and it is not always possible to obtain a print result of which texts are easy for a user to read. For example, a user having difficulty in reading small texts finds difficult to read small texts and to understand the content. In contrast, a user accustomed to reading small texts is dissatisfied with large texts because of a small amount of information. Hence, if a text size is fixed, a print result is outputted that may be difficult for some users to read. Hence, the printer 100 of the first embodiment executes the font changing process in which a font (particularly, text size) is automatically changed depending on a user.

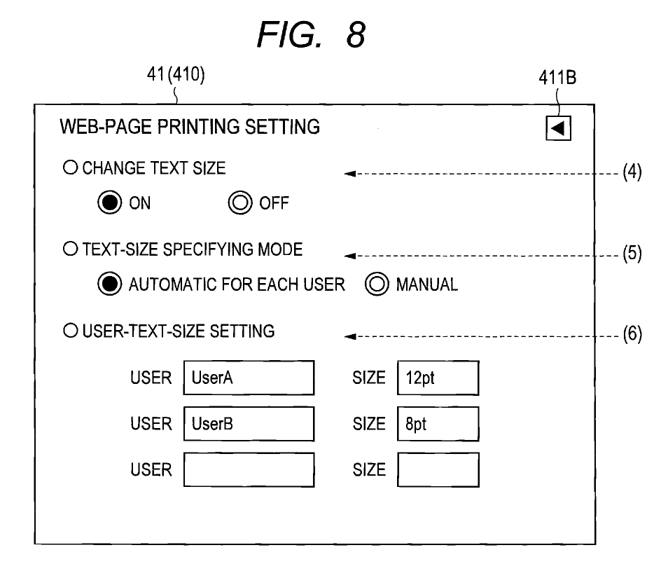

Specifically, the printer 100 displays a switch button 411A on a screen for selecting the frame selection mode shown in FIG. 2. The switch button 411A is a button for switching to a screen for setting a font changing mode. If the switch button 411A is pressed, the display is changed to a screen for setting the font changing mode shown in FIG. 8. The printer 100 also displays a switch button 411B on the screen for selecting the font changing mode shown in FIG. 8. The switch button 411B is a button for switching to the screen for setting the frame selection mode. Thus, the both screens can be switched therebetween. Like the frame selection mode, the user preliminarily performs setting of the font changing mode prior to pressing the OK button which is an instruction for executing Web page printing.

Specifically, a screen for selecting the font changing mode shown in FIG. 8 (the Web-page printing setting screen 410) includes a text-size change setting for setting whether to change a text size ((4) in FIG. 8), a text-size specifying mode setting for setting whether to automatically specify a text size for each user or to manually specify a text size for each job ((5) in FIG. 8), and a user-text-size setting for setting text sizes in association with users when a text size is specified for a user ((6) in FIG. 8). The settings are stored in the NVRAM 34.

In the font changing process shown in FIG. 7, first, the CPU 31 determines whether a font change of texts in a frame is set (S150). Specifically, the CPU 31 determines whether the text-size change setting ((4) in FIG. 8) is ON or OFF. If the text-size change setting is OFF (S150: No), the CPU 31 ends the font changing process without changing the text size.

If the text-size change setting is ON (S150: Yes), the CPU 31 searches for text data included in a selected frame (S151). Then, the CPU 31 determines whether the selected frame includes text data (S152). If the selected frame does not include text data (S152: No), the CPU 31 ends the font changing process because there is no need to change the font.

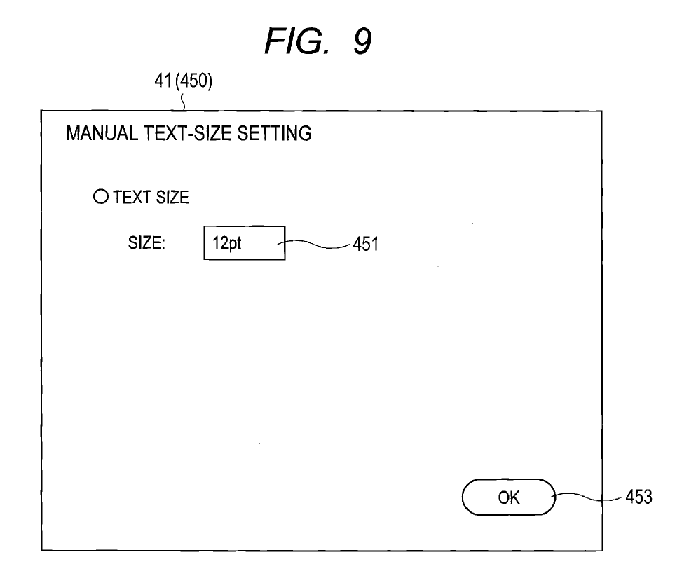

If the selected frame includes text data (S152: Yes), the CPU 31 determines whether the text-size specifying mode setting ((5) in FIG. 8) is automatic setting for each user (S153). If the text-size specifying mode setting is not automatic setting for each user, that is, if the text-size specifying mode setting is manual setting (S153: No), the CPU 31 controls the touch-panel screen 41 of the operation panel 40 to display a manual text-size setting screen 450 shown in FIG. 9 (S154).

The manual text-size setting screen 450 (an example of the text-size specifying section) includes a text box 451 for inputting a text size and an OK button 453. The user inputs a desired text size in the text box 451 and then presses the OK button 453.

If the OK button 453 is pressed, the CPU 31 acquires the text size inputted in the text box 451 (S155).

If the text-size specifying mode setting is automatic setting for each user (S153: Yes), the CPU 31 performs a user authentication (S161, an example of the authenticating section). In the present embodiment, the printer 100 requires the user to input an user ID and password on the touch-panel screen 41 of the operation panel 40, thereby identifying the user who is currently operating the operation panel 40.

Then, the CPU 31 identifies the user and determines whether the text size for the user is set (S162). The text size for each user is set in the user-text-size setting ((6) in FIG. 8) of the Web-page printing setting screen 410. If the text size for the identified user is not set (S162: No), the CPU 31 proceeds to S154 and sets a text size manually. If the text size for the identified user is set (S162: Yes), the CPU 31 acquires the text size from the NVRAM 34 (S163, an example of the text-size acquiring section).

Subsequent to acquisition of the text size in S155 or S163, the CPU 31 changes the text size of texts that are searched in S151 (S156, an example of the first changing section and the second changing section). Subsequent to S156, the CPU 31 ends the font changing process.

As described above, the printer 100 of the first embodiment can set a text size for each user prior to printing and can change the text size of texts included in a print target. Because the user can freely change the text size, the printer 100 of the present embodiment can output a print result that is easy for the user to read.

Further, if the text size for the identified user is set, the text size can be automatically changed to the size suitable to the user. Hence, the user can save a trouble of setting the text size every time.

Note that the above-described font changing process produces a certain advantageous effect, even without frame selection in the Web-page printing process (S102-S107, S111, and S121-S123). That is, an advantageous effect of outputting easy-to-read print results is obtained, even if there is no frame selection process in the Web-page printing process and the font changing process is executed for the frame of a print target.

### Second Embodiment

### Control of Printer Driver

Conventionally, a Web browser or a printer driver has a function of printing an individual frame of a Web page. However, this function does not always ask a user for selection of a frame when a print target includes a plurality of frames, and the user needs to perform setting voluntarily. Hence, there is a possibility that a print result does not meet the use's intention if the user forget performing the setting. Thus, in the present embodiment, the Web-page printing process executed by the printer 100 in the first embodiment is applied to the PC 200.

The Web-page printing process executed by the PC 200 is built in the printer driver 210 as one of functions of the printer driver 210. Hence, the Web-page printing process of the second embodiment is started by the printer driver 210 of the PC 200 upon receipt of an instruction of printing of a Web page (as a trigger) in a state where the Web page is displayed by a Web browser or the like. Note that the same steps as the Web-page printing process (see FIG. 3) in the first embodiment (executed by the printer 100) are designated by the same reference numerals to avoid duplicating description.

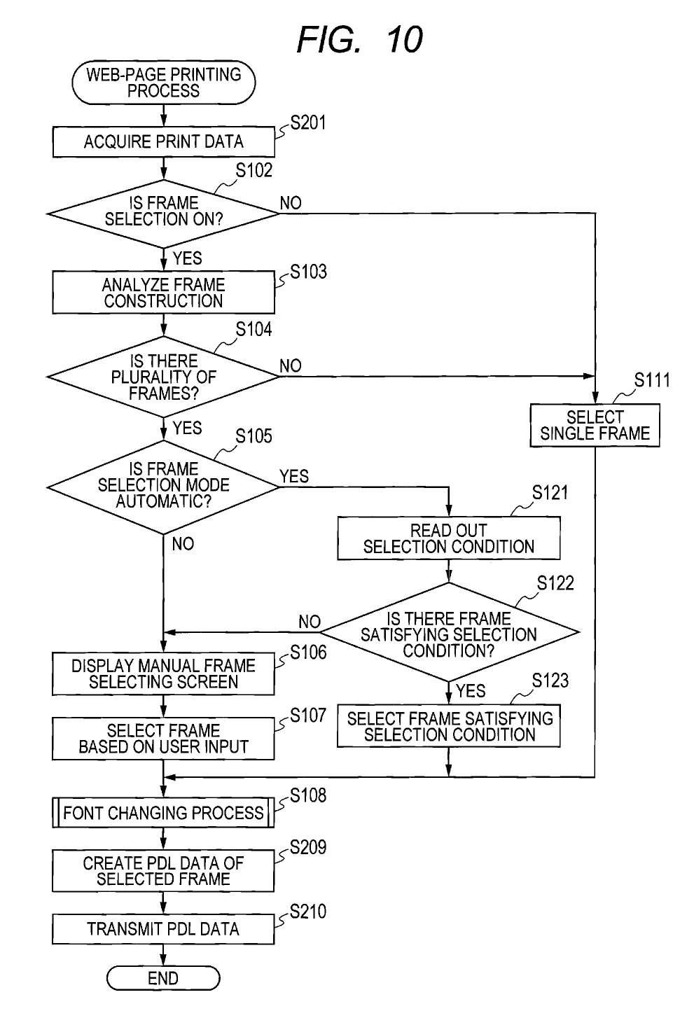

As shown in FIG. 10, in the Web-page printing process of the second embodiment, first, the PC 200 acquires print data (S201). In the PC 200, because a Web browser has already acquired a Web page, the Web browser passes over the print data to the printer driver 210.

Then, the same steps as FIG. 3 are executed from S102 to S108. That is, the PC 200 analyzes frame construction in the print data and selects a frame of a print target. Then, the PC 200 changes a text size of texts included in the frame of the print target as necessary.

Subsequent to S108, the PC 200 creates PDL data for the printer 100 based on data of the selected frame (S209). The PDL data are created based on the frame selected by the user and based on data of which the text size is set by the user. The PC 200 then transmits the PDL data to the printer 100 (S210) and ends the Web-page printing process.

As described above in detail, if print data include a plurality of frames, the printer driver 210 of the PC 200 according to the second embodiment selects a frame of a print target in accordance with a user's manual selection or a selection condition that is preliminarily set by the user, prior to creating PDL data of the print data.

On the other hand, if print data include a single frame, the PC 200 selects the single frame without asking the user. That is, the selection mode is changed depending on whether print data include a plurality of frames. Thus, the user's intention can be reliably reflected in printing, and printing without reflecting the user's intention can be avoided. As a result, this reduces a possibility that a print result against the use's intention is obtained.

### Third Embodiment

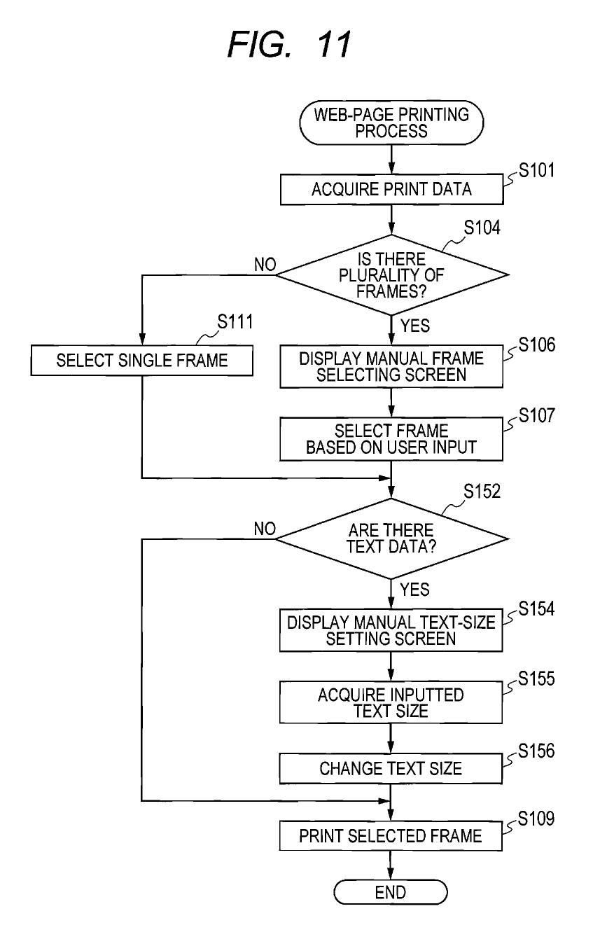

Next, a Web-page printing process according to a third embodiment will be described while referring to the flowchart in FIG. 11. The third embodiment is a relatively simple embodiment, compared with the first embodiment. The CPU 31 of the printer 100 starts the Web-page printing process upon receipt (detection) of pressing of the OK button (as a trigger) after URL information is inputted.

First, the CPU 31 acquires the inputted URL information and acquires print data based on the URL information (S101). That is, the CPU 31 accesses a Web page at a reference location indicated by the URL information and downloads print data.

Next, the CPU 31 determines whether the print data have a plurality of frames (S104). If the print data do not have a plurality of frames, that is, if the print data are constituted by a single frame (S104: No), the CPU 31 selects the single frame (S111) and proceeds to S152.

If the print data have a plurality of frames (S104: Yes), the CPU 31 displays a manual frame selecting screen for allowing the user to select a frame on the touch-panel screen 41 of the operation panel 40 (S106). Here, the CPU 31 displays the frame-map display screen 420 shown in FIG. 4. In the present embodiment, the manual frame selecting screen only includes the frame-map display screen 420, and hence, the frame-map display screen 420 does not show the keyword button 413 and the area-ratio button 414 shown in FIG. 4.

If one of the print buttons 422 and 4225 is pressed on the frame-map display screen 420, the printer 100 selects the frame corresponding to the print button as a print target (S107).

After a frame of the print target is selected in S107 or S111, the CPU 31 executes a font changing process (S152 through S156). The CPU 31 determines whether the selected frame includes text data (S152). If the selected frame does not include text data (S152: No), the CPU 31 proceeds to S109.

If the selected frame includes text data (S152: Yes), the CPU 31 controls the touch-panel screen 41 of the operation panel 40 to display the manual text-size setting screen 450 shown in FIG. 9 (S154). In the manual text-size setting screen 450, the user inputs a desired text size in the text box 451 and then presses the OK button 453. If the OK button 453 is pressed, the CPU 31 acquires the text size inputted in the text box 451 (S155). Subsequent to acquisition of the text size in S155, the CPU 31 changes the text size of texts (S156).

Then, the CPU 31 controls the image forming section 10 to print the frame of the print target (S109). Subsequent to S109, the Web-page printing process ends.

According to the third embodiment, if print data include a plurality of frames, the printer 100 selects a frame of the print target in accordance with a user's manual selection, prior to printing the print data. On the other hand, if print data only include a single frame, the printer 100 prints the single frame without asking the user. Thus, the selection mode is changed depending on whether print data include a plurality of frames. Hence, the user's intention can be reflected in printing.

In addition, according to the third embodiment, the printer 100 can change the text size of texts included in a print target. Because the user can freely change the text size, the printer 100 can output a print result that is easy for the user to read.

### MODIFICATIONS

While the invention has been described in detail with reference to the above aspects thereof, it would be apparent to those skilled in the art that various changes and modifications may be made therein without departing from the scope of the claims. In the following descriptions, like parts and components are designated by the same reference numerals to avoid duplicating description.

For example, the printing device to which the invention is applied may be a printer, a multifunction device, a copier, and the like that have a printing function. Further, the information processing device for supplying the printing device with a print job is not limited to a PC (personal computer), but may be a mobile device such as a smart phone, for example.

In the above-described embodiments, the user inputs URL information prior to executing the Web-page printing process. However, a method of acquiring URL information is not limited to this. For example, it may be so configured that URL information can be registered to the printer 100 through the PC 200 or the like, and the user may select a desired URL information from among registered URLs through the operation panel 40 of the printer 100. Further, the URL information may be stored in association with a frame selection mode (or a text size), so that the frame selection mode (or the text size) can be automatically selected for each piece of URL information.

In the first and second embodiments, as the manual frame selecting screen, the printer 100 or the PC 200 can display three kinds of screens of the frame-map display screen 420 of FIG. 4, the keyword display screen 430 of FIG. 5, and the area-ratio display screen 440 of FIG. 6. However, the manual frame selecting screen is not limited to these. That is, two or less kinds of these screens may be displayed, or four or more kinds of screens may be displayed by adding another selecting screen. For example, if the touch panel screen can only display texts, one of the keyword display screen 430 and the area-ratio display screen 440 may be displayed. Note that, in the third embodiment, the printer 100 displays the frame-map display screen 420.

In the above-described embodiments, information on each frame is informed by means of screen display in the manual frame selecting screen for providing a user with a hint for frame selection. For example, however, information on each frame may be informed with audio guidance or lighting of lamps.

In the above-described embodiments, as the automatic-frame-selection setting in (3) of FIG. 2, the selection condition is selected from among four kinds of selection conditions of: a frame with an image, a frame without an image, a frame having the largest area ratio, and a frame including a keyword. However, the selection condition may be selected from among three or less kinds of selection conditions or may be selected from among five or more kinds of selection conditions.

In the above-described embodiments, manual or automatic frame selection mode can be selected. However, it may be so configured that only one of manual and automatic frame selection mode is used. Even if only automatic frame selection mode is used, the user sets the selection condition of frames. Thus, the use's intention is reflected in a print result.

In the above-described embodiments, the font changing process is executed in the Web-page printing process. However, the font changing process is not always necessary in the Web-page printing process. Further, in the Web-page printing process, even if frame selection is not performed for print data including a plurality of frames and the font changing process is executed, there is still an advantageous effect that an easy-to-read print result can be obtained.

In the first and second embodiments, in the Web-page printing process, determinations are made whether the frame-selection setting is ON (S102) and whether the frame-selection-mode setting is automatic (S105). In the Web-page printing process, however, determinations in S102 and S105 are not always necessary. For example, in a Web-page printing process according to this modification, the CPU 31 acquires inputted URL information and acquires print data based on the URL information (S101), and then analyzes frame construction of the print data acquired in S101 (S103). Next, the CPU 31 determines whether the print data include a plurality of frames (S104) and, if the print data include a plurality of frames (S104: Yes), displays the manual frame selecting screen for allowing the user to select a frame (S106). Then, if a print button is pressed in the frame-map display screen 420, the keyword display screen 430, or the area-ratio display screen 440, the printer 100 selects the frame corresponding to the print button as a print target (S107) and prints the frame of the print target (S109). If the print data include a single frame (S104: No), the CPU 31 selects the single frame (S111) and prints the single frame as the print target (S109). This modification is similar to the third embodiment.

In the above-described embodiments, the printer 100 (or the PC 200) performs acquisition of print data, determination of a plurality of frames, and selection of a frame of a print target. However, the acquisition, determination, and selection need not be performed by a single device. For example, if the printer 100 (or the PC 200) is connected with a server, the server may perform at least one of the above-mentioned acquisition, determination, and selection. Further, for example, the printer 100 may perform acquisition of print data and determination of a plurality of frames, and a user may perform selection of a frame of the print target on the PC 200.

In the above-described embodiments, a single CPU may perform all of the processes. Nevertheless, the disclosure may not be limited to the specific embodiment thereof, and a plurality of CPUs, a special application specific integrated circuit (“ASIC”), or a combination of a CPU and an ASIC may be used to perform the processes.

What is claimed is:

1. A printing device comprising:
an acquiring section configured to access, based on reference information, a reference location on a network and to acquire print data from the reference location;
a determining section configured to determine whether the print data are constituted by a plurality of frames;
a selecting section configured to select at least one of the plurality of frames as a print target based on a user instruction when the determining section determines that the print data are constituted by the plurality of frames, and to select a single frame as the print target when the determining section determines that the print data are constituted by the single frame; and
a printing section configured to print the print target selected by the selecting section.

2. The printing device according to claim 1, further comprising:
an informing section configured to inform a user of information included in each of the plurality of frames when the print data are constituted by the plurality of frames; and
a designating section configured to designate a frame as the print target from among the plurality of frames, based on a user input,
wherein the selecting section is configured to select the frame as the print target in accordance with designation by the designating section.

3. The printing device according to claim 2, wherein the informing section is configured to extract a keyword included in each of the plurality of frames and to inform the user of the keyword.

4. The printing device according to claim 2, wherein the informing section is configured to inform the user of an area ratio of each frame to all of the plurality of frames.

5. The printing device according to claim 2, wherein the informing section is configured to inform the user of a frame layout indicating arrangement relationships among the plurality of frames.

6. The printing device according to claim 1, further comprising:
a condition storage section configured to store a selection condition for selecting the at least one of the plurality of frames as the print target; and
a setting section configured to set the selection condition based on a user instruction,
wherein the selecting section is configured to read out the selection condition from the condition storage section and to select the at least one of the plurality of frames as the print target in accordance with the selection condition, when the determining section determines that the print data are constituted by the plurality of frames.

7. The printing device according to claim 6, wherein the setting section is configured to set the selection condition to select a frame having the largest area ratio in all of the plurality of frames.

8. The printing device according to claim 6, wherein the setting section is configured to set the selection condition to select a frame including a keyword.

9. The printing device according to claim 1, wherein the selecting section is configured to select the print target at a timing subsequent to receiving a print instruction for the print data and prior to starting printing.

10. The printing device according to claim 1, further comprising:
a text-size specifying section configured to specify a text size based on a user input; and
a first changing section configured to change a text size of a text included in the print data into the text size specified by the text-size specifying section.

11. The printing device according to claim 1, further comprising:
an authenticating section configured to perform user authentication;
a text-size storage section configured to store a text size for each user;
a text-size acquiring section configured to acquire, from the text-size storage section, the text size for a user authenticated by the authenticating section; and
a second changing section configured to change a text size of a text included in the print data into the text size acquired by the text-size acquiring section.

12. A storage medium storing a set of program instructions executable on an information processing device, the set of program instructions comprising:
accessing, based on reference information, a reference location on a network and acquiring print data from the reference location;
determining whether the print data are constituted by a plurality of frames; and
selecting at least one of the plurality of frames as a print target based on a user instruction when the print data are constituted by the plurality of frames, and selecting a single frame as the print target when the print data are constituted by the single frame.

13. A printing device comprising:
a processor;
a network interface connectable to a network;
a memory storing a set of program instructions executable by the processor, the set of program instructions comprising:
accessing, based on reference information, a reference location on the network and acquiring print data from the reference location through the network interface;
determining whether the print data are constituted by a plurality of frames; and
selecting at least one of the plurality of frames as a print target based on a user instruction when the print data are constituted by the plurality of frames, and selecting a single frame as the print target when the print data are constituted by the single frame; and
a printing device configured to print the print target.

14. The printing device according to claim 13, wherein the set of program instructions further comprises:
informing a user of information included in each of the plurality of frames when the print data are constituted by the plurality of frames; and
designating a frame as the print target from among the plurality of frames, based on a user input; and
wherein the instructions for selecting at least one of the plurality of frames comprise selecting the designated frame as the print target.

15. The printing device according to claim 14, wherein the instructions for informing a user of information comprise extracting a keyword included in each of the plurality of frames and informing the user of the keyword.

16. The printing device according to claim 14, wherein the instructions for informing a user of information comprise informing the user of an area ratio of each frame to all of the plurality of frames.

17. The printing device according to claim 14, wherein the instructions for informing a user of information comprise informing the user of a frame layout indicating arrangement relationships among the plurality of frames.

18. The printing device according to claim 13, wherein the memory comprises a condition storage section configured to store a selection condition for selecting the at least one of the plurality of frames as the print target;
wherein the set of program instructions further comprises setting the selection condition based on a user instruction; and
wherein the instructions for selecting at least one of the plurality of frames comprise reading out the selection condition from the condition storage section and selecting the at least one of the plurality of frames as the print target in accordance with the selection condition, when the print data are constituted by the plurality of frames.

19. The printing device according to claim 13, wherein the set of program instructions further comprises:
specifying a text size based on a user input; and
changing a text size of a text included in the print data into the text size specified based on the user input.

20. The printing device according to claim 13, wherein the memory comprises a text-size storage section configured to store a text size for each user; and
wherein the set of program instructions further comprises:
performing user authentication;
acquiring, from the text-size storage section, the text size for an authenticated user; and
changing a text size of a text included in the print data into the text size acquired from the text-size storage section.
